(19) United States
(12) Patent Application Publication
(10) Pub. No.: US 2016/0212791 A1
(43) Pub. Date: Jul. 21, 2016

(54) METHODS FOR EFFICIENT WIRELESS COMMUNICATIONS AND COMMUNICATIONS APPARATUS UTILIZING THE SAME

(71) Applicant: MediaTek Inc., Hsin-Chu (TW)

(72) Inventors: Cheng-Hsiao Ko, Hsinchu City (TW); Shih-Chieh Liao, Kaohsiung City (TW); Ming-Wan Hsu, Taipei City (TW); Chih-Kuang Wu, Jhubei City (TW)

(21) Appl. No.: 14/991,371

(22) Filed: Jan. 8, 2016

Related U.S. Application Data
(60) Provisional application No. 62/103,715, filed on Jan. 15, 2015.

(51) Int. Cl. H04W 76/02; H04W 76/04

(52) U.S. Cl. CPC H04W 76/027; H04W 76/046; H04W 88/06

(57) ABSTRACT

A method for efficient wireless communications includes transmitting a connection request via a communications apparatus to a peer device to try to establish a connection with the peer device to trigger a Circuit Switch Fallback (CSFB) procedure; starting a predetermined timer via the communications apparatus when transmitting the connection request; and when there is no response message received from the peer device by the time the predetermined timer expires, transmitting the connection request again via the communications apparatus to the peer device at least once to retry to establish the connection with the peer device.

### CROSS REFERENCE TO RELATED APPLICATIONS

This application claims the benefit of U.S. Provisional Application No. 62/103,715 filed on 2015 Jan. 15 and entitled “Trigger MT CSFB retry when connection establishment failed due to timeout”, the entire contents of which are hereby incorporated by reference.

### BACKGROUND OF THE INVENTION

1. Field of the Invention

The invention relates to methods for efficient wireless communications.

2. Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to another party, from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signalling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Wireless Fidelity (Wi-Fi) is a technology defined by the 802.11 engineering standard and can be used for home networks, mobile phones, video games, to provide a high-frequency wireless local area network. The Long-Term Evolution (LTE) is a standard for wireless communication of high-speed data for mobile phones and data terminals. It is based on the GSM/EDGEand UMTS/HSPA network technologies, increasing the capacity and speed using a different radio interface together with core network improvements.

In order to provide more efficient communications services, methods for efficient wireless communications are provided.

### BRIEF SUMMARY OF THE INVENTION

Methods for efficient wireless communications and communications apparatuses are provided. An exemplary embodiment of a communications apparatus comprises a radio transceiver and a processor. The radio transceiver transmits or receives wireless radio frequency signals to or from a peer device. The processor transmits a connection request to the peer device via the radio transceiver to try to establish a connection with the peer device to trigger a Circuit Switch Fallback (CSFB) procedure, starts a predetermined timer, and when there is no response message received from the peer device by the time the predetermined timer expires, the processor transmits the connection request to the peer device again at least once to retry to establish the connection with the peer device.

An exemplary embodiment of a method for efficient wireless communications comprises transmitting a connection request via a communications apparatus to a peer device to try to establish a connection with the peer device to trigger a Circuit Switch Fallback (CSFB) procedure; starting a predetermined timer via the communications apparatus when transmitting the connection request; and when there is no response message received from the peer device by the time the predetermined timer expires, transmitting the connection request again via the communications apparatus to the peer device at least once to retry to establish the connection with the peer device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows an exemplary block diagram of a communications apparatus according to an embodiment of the invention;

FIG. 1B shows an exemplary block diagram of a communications apparatus according to another embodiment of the invention;

FIG. 2 shows an exemplary block diagram of a modem according to an embodiment of the invention;

FIG. 3 shows an exemplary message flow for the communications apparatus to handle a paging message;

FIG. 4 shows an exemplary flow chart for the communications apparatus to handle a CS paging in an LTE network;

FIG. 5 shows an exemplary flow chart for the communications apparatus to handle a lower layer failure as defined by the 3GPP standards;

FIG. 6 shows an exemplary flow chart of a method for efficient wireless communications according to an embodiment of the invention; and

FIG. 7 shows an exemplary flow chart for the communications apparatus to handle a lower layer failure according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

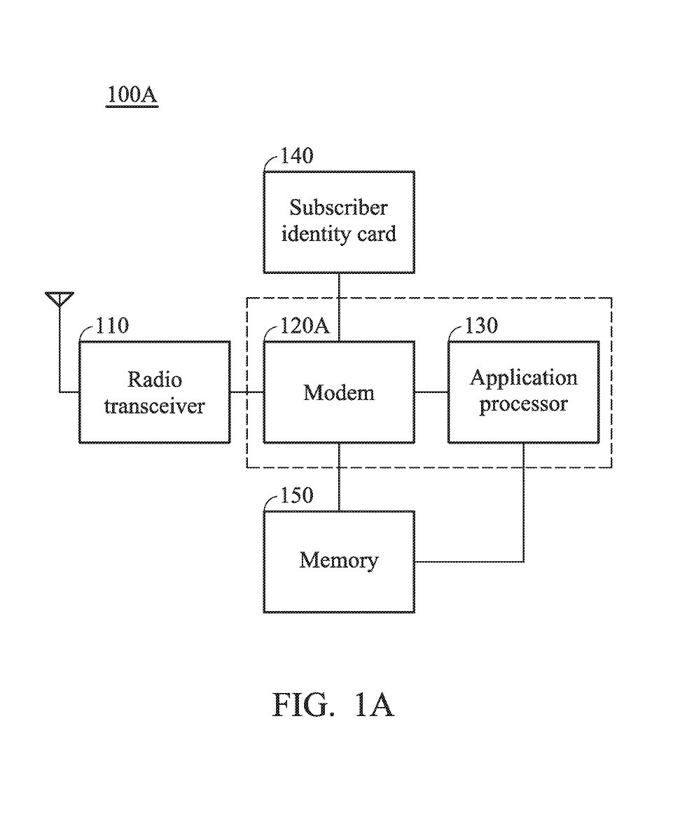

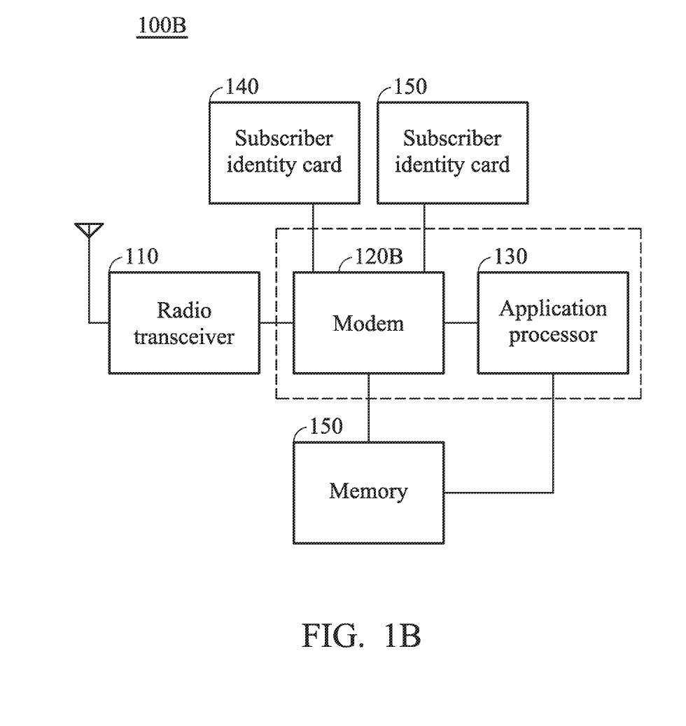

FIG. 1A shows an exemplary block diagram of a communications apparatus according to an embodiment of the invention. The communications apparatus 100A may be a portable electronic device, such as a mobile station (MS, which may be interchangeably referred to as user equipment (UE)). The communications apparatus 100A may comprise at least an antenna module comprising at least one antenna, a radio transceiver 110, a modem 120A, an application processor 130, a subscriber identity card 140, and a memory 150. The radio transceiver 110 may receive wireless radio frequency signals via the antenna module, transmit wireless radio frequency signals via the antenna module and perform RF signal processing. For example, the radio transceiver 110 may convert the received signals to intermediate frequency (IF) or baseband signals to be processed, or receive the IF or baseband signals from the modem 120A and convert the received signals to wireless radio frequency signals to be transmitted to a peer device. According to an embodiment of the invention, the peer device may be a cell, an evolved node B, a base station, etc., at the network side and communicating with the communications apparatus 100A via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portion in the RF signals and/or a mixer for performing radio frequency conversion. According to an embodiment of the invention, the radio frequency may be, for example, 900 MHz or 1800 MHz for a global system for mobile communication (GSM), or 1900 MHz for a Universal Mobile Telecommunications System (UMTS), or the frequency of any specific frequency band for a Long-Term Evolution (LTE) system, etc.

The modem 120A may be a cellular communications modem configured for handling cellular system communications protocol operations and processing the IF or baseband signals received from or to be transmitted to the radio transceiver 110. The application processor 130 is configured for running the operating system of the communications apparatus 100A and running application programs installed in the communications apparatus 100A. In the embodiments of the invention, the modem 120A and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an international mobile subscriber identity (IMSI) and a set of SIM application toolkit (SAT) commands and provides storage space for phone book contacts. The memory 150 may be coupled to the modem 120A and application processor 130 and may store system data or user data.

FIG. 1A shows a case of single-card single-standby application. With advancements in communications techniques, the communications apparatuses are now capable of supporting multi-card multi-standby application and handling multi-RAT's (radio access technology's) operations, such as at least two of GSM/GPRS/EDGE (Global System for Mobile Communications/General Packet Radio Service/Enhanced Data rates for Global Evolution), WCDMA (Wideband Code Division Multiple Access), cdma2000, WiMAX (Worldwide Interoperability for Microwave Access), TD-SCDMA (Time Division Synchronous Code Division Multiple Access), LTE (Long Term Evolution), and TD-LTE (Time Division Long Term Evolution) RATs, or the like via one communications apparatus.

FIG. 1B shows an exemplary block diagram of a communications apparatus according to another embodiment of the invention. Most of the elements shown in FIG. 1B are similar to FIG. 1A, and thus the descriptions are omitted here for brevity. In this embodiment, the communications apparatus 100B may comprise multiple subscriber identity cards 140 and 150 coupled to the modem 120B, thereby the modem 120B may at least support two RATs communications, wherein the two RATs may be different RATs or the same RAT, and the invention should not be limited to either case.

According to an embodiment of the invention, the modem 120B, the radio transceiver 110 and/or the antenna module may be shared by subscriber identity cards 140 and 150 to support at least two RATs communications. Therefore, in this embodiment, the communications apparatus 100B may be regarded as comprising at least two communications units, one may at least comprise the subscriber identity card 140, (all or part of) the modem 120B, the radio transceiver 110 and the antenna module, and another one may at least comprise the subscriber identity card 150, (all or part of) the modem 120B, the radio transceiver 110 and the antenna module.

According to an embodiment of the invention, the modem 120B may have the capability of handling the operations of multiple cellular system communications protocols and processing the IF or baseband signals for the corresponding communications units. Each communications unit may operate independently at the same time in compliance with a corresponding communications protocol, and thereby the communications apparatus 100B can support a multi-card multi-standby application.

Note that, in order to clarify the concept of the invention, FIG. 1A and FIG. 1B present simplified block diagrams in which only the elements relevant to the invention are shown. For example, in some embodiments of the invention, the communications apparatus may further comprise some peripheral devices not shown in FIG. 1A and FIG. 1B. In another example, in some embodiments of the invention, the communications apparatus may further comprise a central controller coupled to the modem 120A/120B and the application processor 130. Therefore, the invention should not be limited to what is shown in FIG. 1A and FIG. 1B.

Note further that subscriber identity cards 140 and 150 may be dedicated hardware cards as described above, or in some embodiments of the invention, may be individual identifiers, numbers, addresses, or the like which are burned in the internal memory device of the corresponding modem and are capable of identifying the individual communications entity that the corresponding communications unit operates. Therefore, the invention should not be limited to what is shown in the figures.

Note further that although communications apparatuses 100B shown in FIG. 1B support two RAT wireless communications services, the invention should not be limited thereto. Those who are skilled in this technology can still make various alterations and modifications based on the descriptions given above to derive the communications apparatuses capable of supporting more than two RAT wireless communications without departing from the scope and spirit of this invention.

Note further that, although in FIG. 1B, the radio transceiver 110 and the antenna module are shared by multiple communications units, the invention should not be limited thereto. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention.

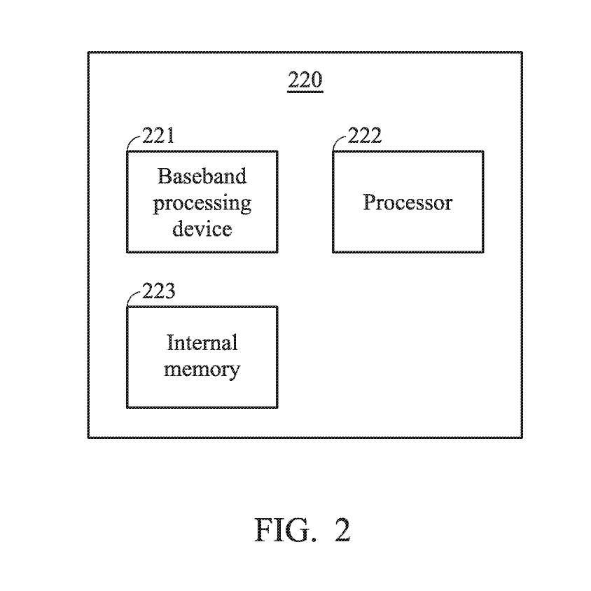

FIG. 2 shows an exemplary block diagram of a modem according to an embodiment of the invention. The modem 220 may be the modem 120A or 120B shown in FIG. 1A and FIG. 1B and may comprise at least a baseband processing device 221, a processor 222 and an internal memory 223. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may further read data from the subscriber identity card coupled to the modem, such as the subscriber identity card 140 and/or 150, and write data to the subscriber identity card. The internal memory 223 may store system data and user data for the modem 220. The processor 222 may also access the internal memory 223.

Note that in order to clarify the concept of the invention, FIG. 2 present simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

According to an embodiment of the invention, the communications apparatus (e.g. the communications apparatus 100A or 100B) may communicate with a peer device (e.g. a cell, an evolved node B, a base station, etc.) by transmitting and receiving a plurality of wireless radio frequency signals. In an example, for the single-card single-standby application as shown in FIG. 1A, the communications apparatus 100A may communicate with a peer device in compliance with a corresponding communications protocol. To be more specific, the communications apparatus 100A may communicate with a peer device before camping on the peer device. The communications apparatus 100A may also perform a predetermined procedure to camp on the peer device, and keep communicating with the peer device after camping on the peer device. The procedure to camp on a peer device (for example, a cell, a base station, an evolved node B, etc., at the network side) is well-known in the art, and is omitted here for brevity.

In another example, for the multi-card multi-standby application as shown in FIG. 1B, each communications unit comprised in the communications apparatus 100B may communicate with a corresponding peer device in compliance with a corresponding communications protocol. To be more specific, each communications unit comprised in the communications apparatus 100B may communicate with a corresponding peer device before camping on the corresponding peer device. Each communications unit comprised in the communications apparatus 100B may also perform a predetermined procedure to camp on the corresponding peer device, and keep communicating with the corresponding peer device after camping on the corresponding peer device.

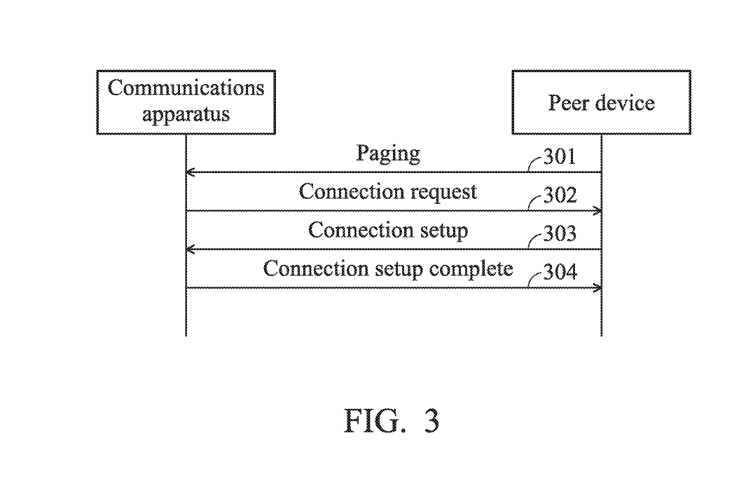

After camping on a corresponding peer device, the communications apparatus (or, the corresponding communications unit, hereinafter using the term communications apparatus for brevity) may operate in an idle mode and listen to the paging from the network. FIG. 3 shows an exemplary message flow for the communications apparatus to handle a paging message. When the communications apparatus receives a paging message 301 from the peer device in the network, the communications apparatus may transmit a connection request message 302 (for example, a radio resource control (RRC) connection request RRCConnectionRequest defined by 3GPP) to the peer device to set up an RRC connection. The peer device in the network may transmit a connection setup message 303 (for example, a RRCConnectionSetup defined by 3GPP) to the communications apparatus in response to the reception of the connection request message 302. The communications apparatus may set up the RRC connection and then respond with a connection setup complete message 304 to the peer device. After transmitting the connection setup complete message 304 (for example, a RRCConnectionSetupComplete defined by 3GPP), the communications apparatus may leave the idle mode and enter the connected mode.

FIG. 3 shows the exemplary message flow when receiving a paging message in a cellular network. When the communications apparatus supports LTE communications and camps on an LTE eNB, a circuit switched fall back (CSFB) procedure to fall back to a legacy network (for example, the 2G or 3G network) is required when receiving a circuit-switched (CS) paging. The processor may check the cn-Domain field in the paging record to determine whether the received paging message is a circuit-switched (CS) paging or a packet-switched (PS) paging.

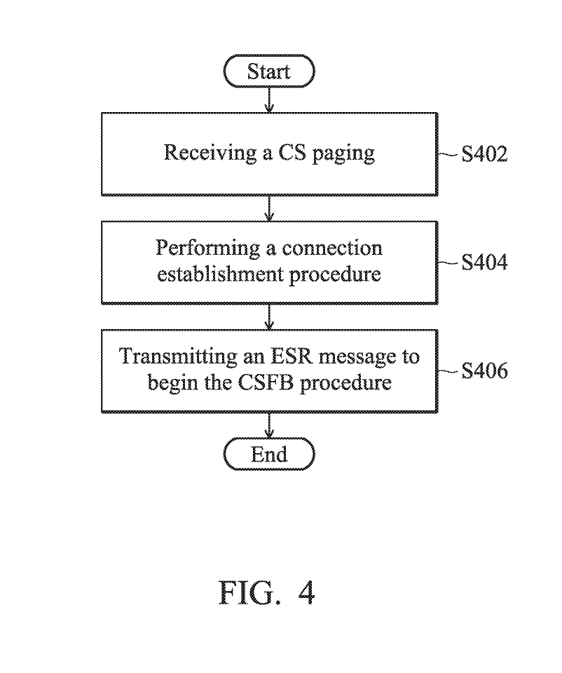

FIG. 4 shows an exemplary flow chart for the communications apparatus to handle a CS paging in an LTE network. When the communications apparatus receives a CS paging message from the camped on peer device (Step S402), which may be an LTE eNB, the communications apparatus may perform a connection establishment procedure (Step S404) to try to establish a connection with the peer device. To be more specific, the communications apparatus may transmit a connection request message as shown in FIG. 3 to the peer device.

When the connection establishment procedure has succeeded, for example, the communications apparatus receives a connection setup message from the peer device as shown in FIG. 3, the communications apparatus may then transmit an Extended Service Request (ESR) message to the peer device to begin the CSFB procedure (Step S406). During the CSFB procedure, the peer device may transmit redirection information to the communications apparatus. In the redirection information, the peer device can indicate a target frequency. Then the communications apparatus may move to the target RAT (for example, 2G or 3G) and search for a suitable cell using the frequency information. CSFB with redirection information may take less time to identify the best cell than a cell selection procedure.

However, the connection establishment procedure may fail. For example, the connection establishment procedure may fail when the communications apparatus is unable to receive any response message from the peer device after transmitting the connection request message. As defined in the 3GPP standards TS 24.301 5.6.1.6, when a lower layer failure occurs, the communications apparatus should perform a cell selection procedure to select to a suitable cell (for example, a 2G or 3G cell) in a legacy network (for example, the GERAN or UTRAN network) by itself and camp on the suitable cell.

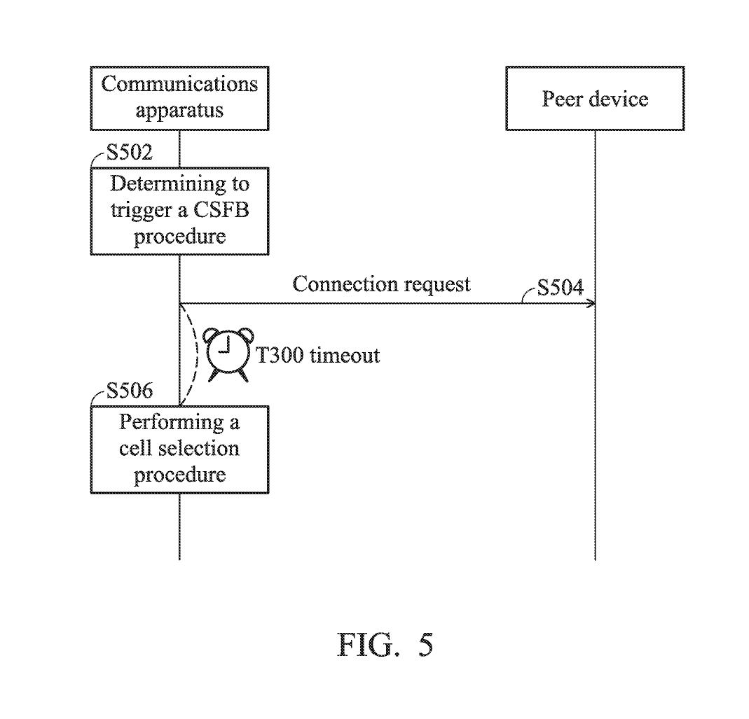

FIG. 5 shows an exemplary flow chart for the communications apparatus to handle a lower layer failure as defined in the 3GPP standards TS 24.301 5.6.1.6. When the communications apparatus determines to trigger a CSFB procedure (Step S502), the communications apparatus may trigger a connection establishment procedure and transmit a connection request message to the peer device (Step S504) to try to establish a connection with the peer device, as discussed above. The communications apparatus may also start a predetermined timer, for example a T300 timer, in the connection establishment procedure.

As defined by the 3GPP standards, the T300 timer is started upon transmission of the connection request message, and is stopped upon receipt of a connection setup message, a connection reject message, a cell re-selection indication message, or upon abortion of connection establishment.

When the T300 timer expires and the communications apparatus is unable to receive any response message from the peer device, the communications apparatus shall perform a cell selection procedure (Step S506) to select GERAN or UTRAN radio access technology by itself. Therefore, as defined by the 3GPP standards, the communications apparatus will try to establish the connection with the peer device only one time. If this trial fails, the communications apparatus should perform a cell selection procedure instead of a CSFB procedure.

However, blindly searching for a suitable cell in the legacy network (for example, the 2G or 3G network) may waste time and may cause the communications apparatus to camp on a cell with bad quality, which may increase a CS call setup failure rate.

To solve this problem, methods for efficient wireless communications are provided.

According to an embodiment of the invention, when determining to trigger a CSFB procedure, the processor (e.g. the processor 222) may transmit a connection request (e.g. a RRCConnectionRequest) to the peer device via the radio transceiver to try to establish a connection with the peer device. Meanwhile, the processor may also start a predetermined timer, for example a T300 timer. When the predetermined timer expires and it is determined that no response message, such as a connection setup message (e.g. a RRCConnectionSetup) or a connection reject message (e.g. a RRCConnectionReject), has been received from the peer device, the processor may transmit the connection request to the peer device again, at least once, to retry to establish the connection with the peer device, which is different from the behavior defined in the 3GPP standards TS 24.301 5.6.1.6.

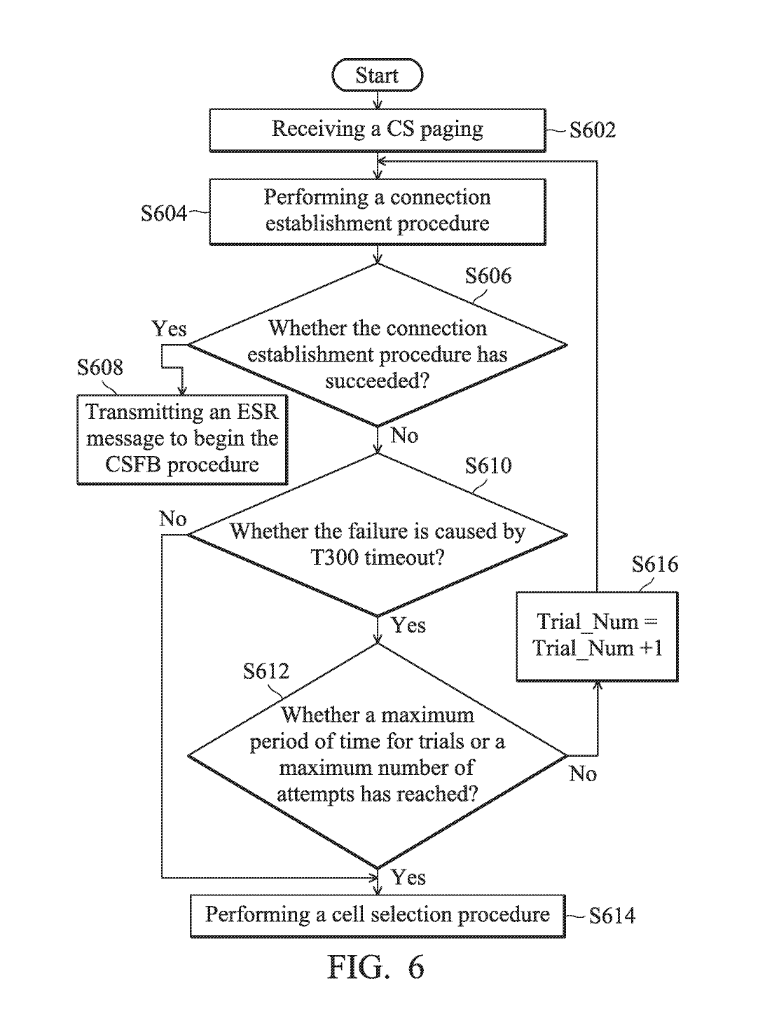

FIG. 6 shows an exemplary flow chart of a method for efficient wireless communications according to an embodiment of the invention. When the communications apparatus receives a CS paging message from the camped on peer device (Step S602), which may be an LTE eNB, the communications apparatus may perform the connection establishment procedure (Step S604) discussed above to try to establish a connection with the peer device.

Then, the processor may check whether the connection establishment procedure has succeeded (Step S606). When the connection establishment procedure has succeeded, the processor may then transmit an ESR message to begin the CSFB procedure (Step S608).

When the connection establishment procedure fails, the processor may check whether the failure is caused by T300 timeout (Step S610). If not, the processor may determine to perform a cell selection procedure as discussed above (Step S614). If the failure is caused by a T300 timeout, the processor may further determine whether the time span for transmitting the connection requests has reached a maximum period of time for trials, or whether the number of times that the connection request has been transmitted has reached a maximum number of attempts (Step S612). Here, the term “reach” means equal to or greater than. If not, the processor may determine to return to step S604 to transmit the connection request to the peer device, again, to retry to establish the connection with the peer device. The value of the parameter Trial_Num used for counting the number of times that the connection request has been transmitted may be set to zero when entering step S604 for the first time, and the processor may increase the value of the parameter Trial_Num by one in step S616 before returning to step S604. The processor may also start the predetermined timer again when returning to step S604 to perform the connection establishment procedure again.

If the time span of transmitting the connection requests has reached the maximum period of time for trials or the number of times that the connection request has been transmitted has reached the maximum number of attempts, the processor may determine to perform a cell selection procedure as discussed above (Step S614).

According to an embodiment of the invention, the processor may determine the maximum period of time for trials and maximum number of attempts according to previous experience. The processor may start calculating the time span of transmitting the connection requests when entering step S604 for the first time.

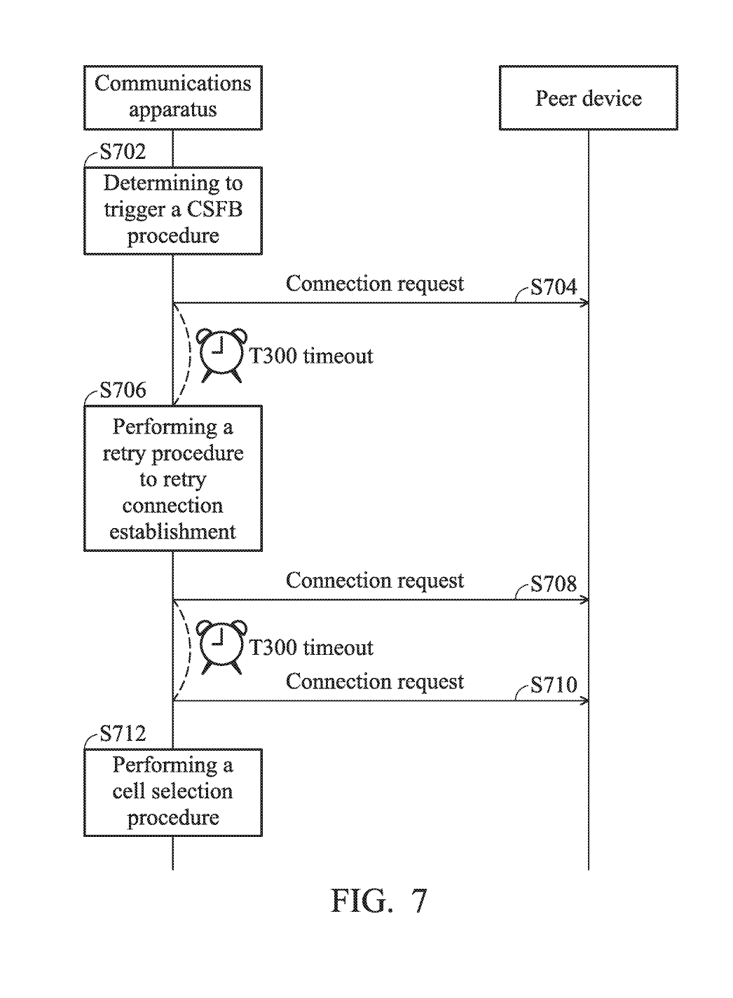

FIG. 7 shows an exemplary flow chart for the communications apparatus to handle a lower layer failure according to an embodiment of the invention. When the communications apparatus determines to trigger a CSFB procedure (Step S702), the communications apparatus may determine to perform the connection establishment procedure and transmit a connection request message to the peer device (Step S704) to try to establish a connection with the peer device in the connection establishment procedure as discussed above. The communications apparatus may also start a predetermined timer, for example, a T300 timer, as discussed above.

When the T300 timer expires and communications apparatus is unable to receive any response message from the peer device, the communications apparatus may determine to begin a retry procedure to retry to establish the connection with the peer device (Step S706) and transmit the connection request message to the peer device again (Step S708). The communications apparatus may also start the T300 timer again.

When the T300 timer expires and communications apparatus is still unable to receive any response message from the peer device, and when a time span of transmitting the connection requests does not reach a maximum period of time for trials and the number of times that the connection request has been transmitted does not reach a maximum number of attempts, the communications apparatus may transmit the connection request message to the peer device again (Step S710) and start the T300 timer again. Note that in the embodiments of the invention, one or more connection request messages can be transmitted in the retry procedure to retry to establish the connection with the peer device.

When the time span of transmitting the connection requests has reached the maximum period of time for trials or the number of times that the connection request has been transmitted has reached the maximum number of attempts, the processor may determine to stop the retry procedure and perform a cell selection procedure, as discussed above (Step S712).

Compared with the behavior defined by the 3GPP standards as shown in FIG. 5, in which the communications apparatus directly performs the cell selection procedure right after the first connection establishment attempt fails, in the embodiments of the invention, a retry procedure will be triggered to retry to establish the connection with the peer device again at least one time. Therefore, in cases where the communications apparatus is temporarily in a bad service area, or for some reason the peer device is temporarily unable to receive the connection request message or unable to transmit a response message, the connection establishment may succeed in the retry procedure by applying the methods discussed above. Therefore, in the embodiments of the invention, inefficient cell selection procedures may be avoid because the CSFB procedure can be triggered after the retry procedure has succeeded, and redirection information can be obtained successfully from the peer device.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, comprising:
a radio transceiver, transmitting or receiving wireless radio frequency signals to or from a peer device; and
a processor, transmitting a connection request to the peer device via the radio transceiver to try to establish a connection with the peer device to trigger a Circuit Switch Fallback (CSFB) procedure, starting a predetermined timer, and when there is no response message received from the peer device by the time the predetermined timer expires, transmitting the connection request to the peer device again at least once to retry to establish the connection with the peer device.

2. The communications apparatus as claimed in claim 1, wherein the response message is a connection setup message or a connection reject message.

3. The communications apparatus as claimed in claim 1, wherein the predetermined timer is a T300 timer.

4. The communications apparatus as claimed in claim 1, wherein the processor determines whether a time span of transmitting the connection requests has reached a maximum period of time for trials, and triggers a cell selection procedure to camp on a legacy network when the time span has reached the maximum period of time for trials.

5. The communications apparatus as claimed in claim 1, wherein the processor determines whether the number of times that the connection request has been transmitted has reached a maximum number of attempts, and triggers a cell selection procedure to camp on a legacy network when that number has reached the maximum number of attempts.

6. The communications apparatus as claimed in claim 1, wherein the processor starts the predetermined timer again when transmitting the connection request to the peer device again.

7. The communications apparatus as claimed in claim 1, wherein the connection request is a RRCConnectionRequest message defined by 3GPP, and the response message is a RRCConnectionSetup message or a RRCConnectionReject message defined by 3GPP.

8. A method for efficient wireless communications, comprising:
transmitting a connection request via a communications apparatus to a peer device to try to establish a connection with the peer device to trigger a Circuit Switch Fallback (CSFB) procedure;
starting a predetermined timer via the communications apparatus when transmitting the connection request; and
when there is no response message received from the peer device by the time the predetermined timer expires, transmitting the connection request again via the communications apparatus to the peer device at least once to retry to establish the connection with the peer device.

9. The method as claimed in claim 8, wherein the response message is a connection setup message or a connection reject message.

10. The method as claimed in claim 8, wherein the predetermined timer is a T300 timer.

11. The method as claimed in claim 8, further comprising:
determining whether a time span of transmitting the connection requests has reached the maximum period of time for trials; and
triggering a cell selection procedure to camp on a legacy network when the time span has reached the maximum period of time for trials.

12. The method as claimed in claim 8, further comprising:
determining whether the number of times that the connection request has been transmitted has reached a maximum number of attempts; and
triggering a cell selection procedure to camp on a legacy network when that number has reached the maximum number of attempts.

13. The method as claimed in claim 8, further comprising:
starting the predetermined timer again when transmitting the connection request to the peer device again.

14. The method as claimed in claim 8, wherein the connection request is a RRCConnectionRequest message defined by 3GPP, and the response message is a RRCConnectionSetup message or a RRCConnectionReject message defined by 3GPP.
